(19) United States
(12) Patent Application Publication
(10) Pub. No.: US 2003/0046336 A1
(43) Pub. Date: Mar. 6, 2003

(54) Persistent link for broadband mobile platform communicatons systems using proxy servers

(76) Inventors: Michael A. D'Annunzio, Redmond, WA (US); Stanley K. Tazuma, Kirkland, WA (US); Scott Jorgenson, Sumner, WA (US)

Correspondence Address: HARNESS, DICKEY & PIERCE, P.L.C., P.O. BOX 828, BLOOMFIELD HILLS, MI, 48303, US

(21) Appl. No.: 09/943,838

(22) Filed: Aug. 31, 2001

(51) Int. Cl. G06F 15/16

(52) U.S. Cl. 709/203

(57) ABSTRACT

A communications system according to the invention provides a communications link between a distributed communications system and a mobile platform via a satellite. The communications system includes a ground station and a parent proxy server connected to the ground station. A distributed communications system is connected to the parent proxy server. A satellite communicates with the ground station. A transceiver, a router and a child proxy server are located on the mobile platform. A user communication device (UCD) is connected to the child proxy server. The child and parent proxy servers establish a persistent transmission control protocol (TCP) link between the mobile platform and the ground station. The UCD connects to the child proxy server using a first group of TCP settings. The child and parent proxy servers communicate using a second group of TCP settings to optimize the TCP link for long delay satellite links.

### FIELD OF THE INVENTION

The present invention relates to broadband communication systems for mobile platforms, and more particularly to a persistent transmission control protocol (TCP) link using proxy servers.

### BACKGROUND OF THE INVENTION

Broadband communications access, on which our society and economy is growing increasingly dependent, are not readily available to users on board mobile platforms such as aircraft, ships, and trains. While the technology exists to deliver the broadband communications services to mobile platforms, conventional solutions are commercially unfeasible due to the high costs or low data rates. The conventional solutions have therefore only been available to government/military users and/or to high-end maritime markets such as cruise ships.

The Internet is a packet-switched network. When a user sends information across the Internet to another computer, the data is broken into small packets which are also known as segments. Routers direct the packets across the Internet individually. When the packets arrive at the destination computer, the packets are recombined into their original form. Two different protocols handle the work of breaking the data into packets, routing the packets across the Internet and recombining the packets on the other end. Internet protocol (IP) routes data packets without regard to proper sequencing or duplication and allows packets to be dropped. Transmission control protocol (TCP) adds reliability to IP by checking for proper sequencing of packets, duplicate packets, and damaged packets. TCP also requests retransmission of damaged or missing packets.

TCP assigns a header to each packet of data. The header contains information such a sequence number that enables the reassembly of packets into their original order. As TCP creates each packet, it also calculates and adds a checksum. The checksum is a number that TCP uses to determine whether an error occurred during transmission. The checksum is based on the precise amount of data in the packet. Each packet is enclosed in a separate IP envelope that contains address information for instructing the routers. All of the envelopes for a given packet of data have the same address information so that all are sent to the same destination for reassembly. The IP envelopes contain headers that include information such as the sender's address, the destination address, the amount of time that the packets should be kept before discarding the packet, and other information.

As the packets are sent across the Internet, the routers examine the IP envelopes and look at their addresses. The routers determine the most efficient path for sending each packet. After traveling through a series of routers, the packets arrive at the recipient's computer. Because the traffic load on the Internet varies constantly, the individual packets may be sent along different routes and may arrive at the destination computer out of order.

As the packets arrive at the destination computer, TCP calculates the checksum for each packet. If the calculated checksum matches the checksum contained in the packet, the TCP packet does not contain errors. If the checksum does not match, TCP knows that the data in a packet has been corrupted during transmission. TCP discards the packet and sends a request back to the sender that the corrupted packet be retransmitted. As the destination computer receives the non-corrupt packets, TCP assembles the packets into their original sequence and presents the data to the requesting process.

When providing communications for passengers on board mobile platforms, satellites typically provide a radio frequency (RF) communication link between the mobile platform and a ground station. TCP provides reliable delivery of data across the network path that includes the RF communications link. There is a delay in the delivery of a message over the satellite link due to the finite speed of light and the altitude of communication satellites. Many communications satellites are located at geosynchronous orbit with the altitude of approximately 36,000 kilometers. At this altitude, the orbit period is the same as the earth's rotational period. The propagation time for a radio signal to travel twice that distance is 240 milliseconds. For ground stations at the edge of a view area of the satellite, the distance traveled is longer and the propagation delay is approximately 280 milliseconds. These delays are for one ground station to satellite to ground station route or “hop”. Therefore, the propagation delay for a message and the corresponding reply will typically range from 480-560 milliseconds. The round-trip time is increased by other factors in the network such as the transmission and propagation times of other links and the delays in the gateways.

The satellite channels are also impacted by noise and bandwidth more than terrestrial links. The strength of the RF signal falls in proportion to the square of the distance traveled. For a satellite link, the distance is large and the signal becomes weak before reaching its destination. Because the radio spectrum is a limited natural resource, there is a restricted amount of bandwidth that is available to satellite systems. The scarcity of bandwidth makes it difficult to trade bandwidth to solve other design problems. As a result of noise, satellite channels also exhibit a higher bit error rate than terrestrial networks. Therefore, satellite links have higher rates of corrupt packets than other networks.

TCP construes packet drops or corruption as a sign of network congestion and reduces its packet window size to alleviate the congestion. Without knowing why a packet was dropped, TCP assumes that the drop was due to network congestion to avoid potential congestion collapse of the network. Therefore, packets dropped due to corruption cause TCP to reduce the packet window size even if the packets were not dropped due to congestion. Still other problems that are unique to satellite links include asymmetric satellite networks. Satellite networks often have a forward link with greater available capacity than the return link and may use separate satellites and ground stations for the forward and return links.

To avoid generating an inappropriate amount of network traffic for the current network conditions, TCP employs four main congestion control mechanisms: slow start; congestion avoidance; fast retransmit; slow-start-restart; and, fast recovery. These algorithms are used to adjust the amount of acknowledged data that can be injected into the network and to retransmit signals that were dropped by the network.

TCP uses state variables to control congestion. The first state variable is a congestion window that is an upper bound on the amount of data that the sender can inject into the network before receiving an acknowledgment. The value of the congestion window variable is limited to the receiver's advertised window. The congestion window variable is increased or decreased during the transfer based on the amount of congestion present on the network. The second state variable is the slow start threshold that determines which algorithm is used to increase the value of the congestion window variable. If the congestion window variable is less than the slow start threshold, the slow start algorithm is used to increase the value of the congestion window variable. However, if the congestion window variable is greater than or equal to the slow start threshold, the congestion avoidance algorithm is used.

When a host begins sending data on a TCP connection, the host has no knowledge of the current state of the network between itself and the receiver. In order to avoid transmitting an inappropriately large burst of traffic, the data sender is required to use the slow start algorithm at the beginning of each new transfer. Therefore, each time a passenger on board a mobile platform begins a transfer, the slow start algorithm is initiated. The slow start algorithm begins by initializing the congestion window to one segment and the slow start threshold to the receiver's advertised window. This forces TCP to transmit one segment and wait for the corresponding acknowledgment. For each acknowledgement that is received during the slow start algorithm, the value of the congestion window is increased by one segment.

When the value of the congestion window variable is greater than or equal to the slow start threshold, the congestion avoidance algorithm is used to increase the congestion window variable. The congestion control algorithm increases the size of the congestion window variable more slowly than the slow start algorithm. Congestion avoidance is used to slowly probe the network for additional capacity.

The slow start and congestion control algorithms do not adequately support the utilization of the available channel bandwidth when using long-delay satellite networks. For example, transmission begins with one segment. After the first segment is transmitted, the sender is forced to wait for the corresponding acknowledgment. When using a geosynchronous satellite, this leads to an idle time of roughly 500-700 milliseconds during which no useful work is accomplished. TCP's default mechanism to detect dropped segments is a timeout. In other words, if the sender does not receive an acknowledgment for a given packet within the expected amount of time, the segment will be retransmitted. The retransmission timeout is based on observations of the round-trip time.

While most browsers allow users to vary the TCP settings to optimize parameters for a particular network, the knowledge required to change the settings is typically beyond that of the typical business traveler. In addition, each time that the business traveler sends data, the TCP connection must be re-established and the slow start algorithm slowly ramps up transmission data rates.

Therefore, it would be desirable to optimize RF communication links of mobile platform communications systems.

### SUMMARY OF THE INVENTION

A communications system according to the invention provides a communications link between a distributed communications system and a mobile platform via a satellite. The communications system includes a ground station and a parent proxy server connected to the ground station. A distributed communications system is connected to the parent proxy server. A satellite communicates with the ground station. A transceiver is located on a mobile platform and communicates with the satellite. A router is connected to the transceiver. A child proxy server is connected to the router. A user communication device (UCD) is connected to the child proxy server. The child and parent proxy servers establish a persistent transmission control protocol (TCP) link between the mobile platform and the ground station.

According to other features of the invention, the UCD connects to the child proxy server using a first group of TCP settings. The child and parent proxy servers communicate using a second group of TCP settings. The web cache service is located on the mobile platform and is connected to the child proxy server.

According to still other features of the invention, the web cache service stores web pages. The child proxy server accesses the web pages in the web cache service if the UCD requests access to the web pages.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a functional block diagram illustrating broadband communication system between mobile platforms and a ground-based communications system;

FIG. 2 illustrates proxy servers used in the broadband communications system of FIG. 1 to establish a persistent TCP link; and

FIG. 3 is a functional block diagram illustrating an exemplary mobile platform communication system.

### DETAILED DESCRIPTION OF THE PREFERRED EMBODIMENTS

The following description of the preferred embodiment(s) is merely exemplary in nature and is in no way intended to limit the invention, its application, or uses.

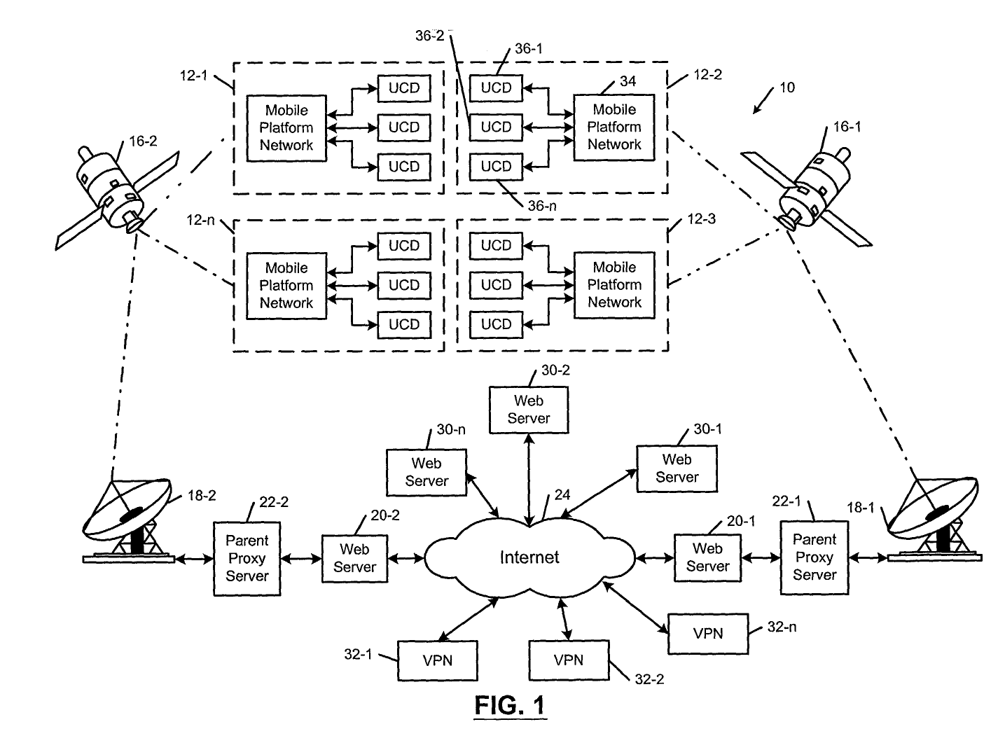

Referring now to FIG. 1, a mobile platform communications system 10 for mobile platforms 12-1, 12-2, 12-3, . . . , 12-n is shown. The mobile platforms 12 communicate via one or more satellites 16-1, 16-2, . . . , 16-n with one or more ground-based receiving stations 18-1, 18-2, . . . , 18-n. The ground-based receiving stations 18 are connected to web servers 22-1, 22-2, . . . , 22-n via parent proxy servers 20-1, 20-2, . . . , 20-n. The web servers 22 are connected to a distributed communications system 24 such as the Internet.

One or more web servers 30-1, 30-2, . . . , 30-n that provide content such as news, music, movies, etc. are connected to the distributed communications system 24. Likewise, one or more virtual private networks (VPNs) 32-1, 32-2, . . . , 32-n such as corporate private networks are connected to the distributed communications system 24. The mobile platforms 12 include a mobile platform network 34 and user communications devices (UCD) 36-1, 36-2, . . . , 36-n that are connected to the mobile platform network 34. The UCD 36 are preferably a laptop computer, a personal digital assistant (PDA), or any other electronic device that includes a browser and that can communicate via the Internet. The UCD 36 preferably include a microprocessor, memory (such as random access memory, read-only memory, and/or flash memory), and input/output devices such as a keyboard, a mouse, and/or a voice operated interface.

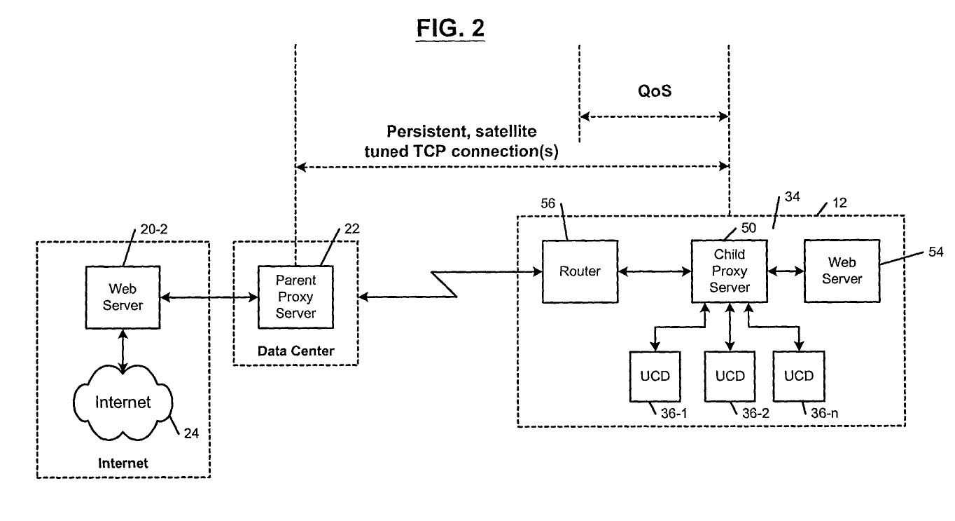

Referring now to FIGS. 1 and 2, the present invention establishes persistent satellite TCP connections using parent and child proxy servers that are associated with the ground station and the mobile platform. The parent proxy servers 22 are connected between the ground station 18 and the web server 20. Likewise, a child proxy server 50 is connected to a web server 54, the UCDs 36 and a router 56 on the mobile platform 12. The child proxy server 50 on the mobile platform and the parent proxy server 22 establish a persistent, satellite-tuned TCP connection as will be described further below. By employing the parent and child proxy servers, the TCP state variables, congestion algorithms and other parameters are optimized for the long delay satellite links. As a result of using the parent and child proxy servers, the mobile platform communication system 10 optimizes the TCP connection for the long delays of satellite links, the higher transmission errors, the asymmetric links, and the large delay*bandwidth products.

By providing the parent and child proxy servers 22 and 50, larger initial TCP windows can be used as compared with systems without proxy servers. In addition, selective acknowledgments can be employed. Since the mobile platform communications system is a private network, some settings that are not appropriate for shared networks can also be employed. TCP extensions can also be used for transactions.

Referring now to FIG. 2, the present invention establishes persistent satellite TCP connections using proxy servers associated with the ground station and the mobile platform. By employing the parent and child proxy servers in the network, the TCP state variables and congestion algorithms can be optimized for the satellite links. The mobile platform communication system 10 also optimizes the TCP connection for the long delays of satellite links, the higher transmission errors, the asymmetric links, and the large delay*bandwidth products. The child proxy server 50 on the mobile platform 12 and the parent proxy server 22 establish a persistent, satellite-tuned TCP connection as will be described further below.

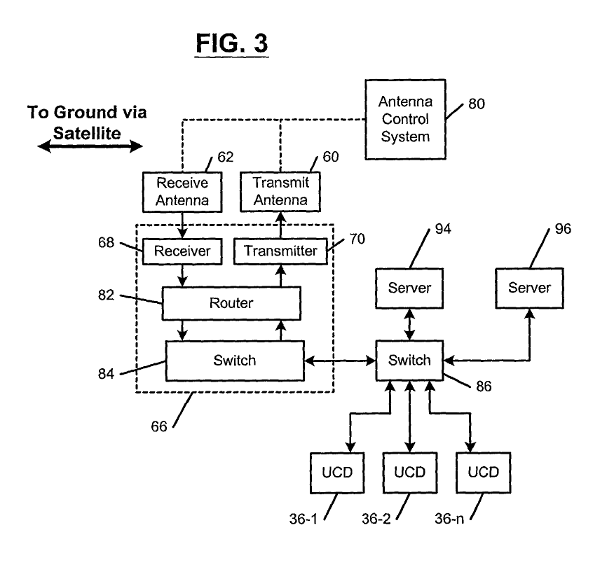

Referring now to FIG. 3, an exemplary mobile platform communication system is shown. A transmit antenna 60 and a receive antenna 62 are connected to a data transceiver router (DTR) 66. The DTR 66 includes a receiver 68 that is connected to the receive antenna 62. The DTR 66 includes a transmitter 70 that is connected to the transmit antenna 60. The transmit and receive antennas 60 and 62 are controlled by an antenna control system 80. The transmitter 70 and the receiver 68 are connected to a router 82 and a switch 84.

The switch 84 is connected to a switch 86 that is connected to servers 94 and 96 and UCDs 36. The servers 94 and 96 preferably provide the proxy server and the web server functions for the mobile platform 12. Skilled artisans can appreciate that the proxy server functions can be provided by another server and/or be connected to the network in a different manner.

The persistent TCP link provided by parent and child proxy servers 22 and 50 according to the invention can be enhanced for satellite links using lower level mitigations (forward error correction (FEC)). Path MTU discovery allows TCP to use the largest possible packet size without incurring the cost of fragmentation and reassembly. Other functions that can be optimized include slow start and congestion avoidance, fast retransmit and fast recovery, large TCP windows, acknowledgment strategies such as delayed and selective acknowledgments.

In addition to the optimization of existing TCP functions and settings, the present invention will also be able to take advantage of proposed TCP functions that will further optimize TCP over satellite links. TCP uses a three-way handshake to setup a connection between two hosts. This connection setup requires 1-1.5 round-trip times (RTTs), depending upon whether the data sender started the connection actively or passively. This startup time is eliminated by using TCP extensions for transactions (T/TCP). After the first connection between a pair of hosts is established, T/TCP is able to bypass the three-way handshake, allowing the data sender to begin transmitting data in the first segment sent (along with the SYN). This is especially helpful for short request/response traffic, as it saves a potentially long setup phase when no useful data is being transmitted.

As discussed above, TCP senders use the number of incoming acknowledgements to increase the congestion window during slow start. Since delayed acknowledgements reduce the number of acknowledgements returned by the receiver by roughly half, the rate of growth of the congestion window is reduced. One proposed solution to this problem is to use delayed acknowledgements only after the slow start phase. This provides more acknowledgements while TCP is aggressively increasing the congestion window and less acknowledgements while TCP is in steady state, which conserves network resources.

The wide-spread use of delayed acknowledgements increases the time needed by a TCP sender to increase the size of the congestion window during slow start. This is especially harmful to flows traversing long-delay geosynchronous satellite links. One mechanism that has been suggested to mitigate the problems caused by delayed acknowledgements is the use of “byte counting” rather than standard acknowledgement counting. Using standard acknowledgement counting, the congestion window is increased by 1 segment for each acknowledgement received during slow start. However, using byte counting, the congestion window increase is based on the number of previously unacknowledged bytes covered by each incoming acknowledgement rather than on the number of acknowledgements received. This makes the increase proportional to the amount of data transmitted rather than being dependent on the acknowledgement interval used by the receiver.

TCP senders use the number of incoming acknowledgements to increase the congestion window during slow start. Since delayed acknowledgements reduce the number of acknowledgements returned by the receiver by roughly half, the rate of growth of the congestion window is reduced. One proposed solution to this problem is to use delayed ACKs only after the slow start phase. This provides more acknowledgements while TCP is aggressively increasing the congestion window and less acknowledgements while TCP is in steady state, which conserves network resources. In simulation, using delayed acknowledgements after slow start improves the transfer time when compared to a receiver that always generates delayed acknowledgements. However, slow start also slightly increases the loss rate due to the increased rate of congestion window growth.

The initial slow start phase is used by TCP to determine an appropriate congestion window size for the given network conditions. Slow start is terminated when TCP detects congestion or when the size of congestion window reaches the size of the receiver's advertised window. Slow start is also terminated if congestion window grows beyond a certain size. The threshold at which TCP ends slow start and begins using the congestion avoidance algorithm is called “ssthresh”. In most implementations, the initial value for ssthresh is the receiver's advertised window. During slow start, TCP roughly doubles the size of the congestion window every RTT and therefore can overwhelm the network with at most twice as many segments as the network can handle. By setting ssthresh to a value less than the receiver's advertised window initially, the sender may avoid overwhelming the network with twice the appropriate number of segments. One approach uses a packet-pair algorithm and the measured RTT to determine a more appropriate value for ssthresh. The algorithm observes the spacing between the first few returning acknowledgements to determine the bandwidth of the bottleneck link. Together with the measured RTT, the delay*bandwidth product is determined and ssthresh is set to this value. When TCP's congestion window reaches this reduced ssthresh, slow start is terminated and transmission continues using congestion avoidance, which is a more conservative algorithm for increasing the size of the congestion window.

The Forward Acknowledgment (FACK) algorithm was developed to improve TCP congestion control during loss recovery. FACK uses TCP SACK options to glean additional information about the congestion state, adding more precise control to the injection of data into the network during recovery. FACK decouples the congestion control algorithms from the data recovery algorithms to provide a simple and direct way to use SACK to improve congestion control. Due to the separation of these two algorithms, new data may be sent during recovery to sustain TCP's self-clock when there is no further data to retransmit.

Slow-start takes several round trips to fully open the TCP congestion window. For short TCP connections (such as WWW traffic with HTTP/1.0), the slow-start overhead can preclude effective use of the high-bandwidth satellite links. When senders implement slow-start restart after a TCP connection goes idle, performance is reduced in long-lived (but bursty) connections (such as HTTP/1.1, which uses persistent TCP connections to transfer multiple WWW page elements).

Acknowledgement Congestion Control (ACC) extends the concept of flow control for data segments to acknowledgment segments. Any intermediate router can mark an acknowledgment with an Explicit Congestion Notification (ECN) bit once the queue occupancy in the router exceeds a given threshold. The data sender (which receives the acknowledgment) must “echo” the ECN bit back to the data receiver. The proposed algorithm for marking acknowledgement segments with an ECN bit is Random Early Detection (RED). In response to the receipt of ECN marked data segments, the receiver dynamically reduces the rate of acknowledgments using a multiplicative backoff. Once segments without ECN are received, the data receiver speeds up acknowledgments using a linear increase, up to a rate of either 1 (no delayed ACKs) or 2 (normal delayed ACKs) data segments per ACK. The acknowledgment is generated at least once per window, and ideally a few times per window.

ACK Filtering (AF) is designed to address the same ACK congestion effects described above. Contrary to ACC, however, AF is designed to operate without host modifications. AF takes advantage of the cumulative acknowledgment structure of TCP. The bottleneck router in the reverse direction (the low speed link) must be modified to implement AF. Upon receipt of a segment which represents a TCP acknowledgment, the router scans the queue for redundant ACKs for the same connection, i.e. ACKs which acknowledge portions of the window which are included in the most recent ACK. All of these “earlier” ACKs are removed from the queue and discarded.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, specification, and following claims.

What is claimed is:

1. A communications system for providing a communications link between a ground station and a mobile platform via a satellite, comprising:
a parent proxy server connected to a ground station;
a child proxy server located on a mobile platform;
wherein said child and parent proxy servers establish a persistent transmission control protocol (TCP) link between said mobile platform and said ground station.

2. The communications system of claim 1 further comprising:
a user communication device (UCD) located on said mobile platform and connected to said child proxy server.

3. The communications system of claim 2 further comprising:
a router that is located on said mobile platform and that is connected to said child proxy server.

4. The communications system of claim 3 further comprising:
a web cache service that is located on said mobile platform and that is connected to said child proxy server.

5. The communications system of claim 4 wherein said web cache service stores web pages in cache.

6. The communications system of claim 5 wherein said child proxy server accesses said web pages in said web cache service if said UCD requests access to said web pages.

7. A communications system for providing a communications link between a distributed communications system and a mobile platform via a satellite, comprising:
a ground station;
a parent proxy server connected to said ground station;
a distributed communications system connected to said parent proxy server;
a satellite that communicates with said ground station;
a transceiver located on a mobile platform that communicates with said satellite;
a router connected to said transceiver;
a child proxy server connected to said router; and
a user communication device (UCD) connected to said child proxy server,
wherein said child and parent proxy servers establish a persistent transmission control protocol (TCP) link between said mobile platform and said ground station.

8. The communications system of claim 7 wherein said UCD connects to said child proxy server using a first group of TCP settings.

9. The communications system of claim 8 wherein said parent and child proxy servers communicate using a second group of TCP settings.

10. The communications system of claim 7 further comprising:
a web cache service that is located on said mobile platform and that is connected to said child proxy server.

11. The communications system of claim 10 wherein said web cache service stores web pages.

12. The communications system of claim 11 wherein said child proxy server accesses said web pages in said web cache service if said UCD requests access to said web pages.

13. A method for providing a communications link between a ground station and a mobile platform via a satellite, comprising the steps of:
connecting a parent proxy server to a ground station;
providing a child proxy server on a mobile platform; and
establishing a persistent transmission control protocol (TCP) link using said child and parent proxy servers between said mobile platform and said ground station.

14. The method of claim 13 further comprising the steps of:
connecting a user communication device (UCD) located on said mobile platform to said child proxy server.

15. The method of claim 14 further comprising the steps of:
connecting a router that is located on said mobile platform to said child proxy server.

16. The method of claim 15 further comprising the steps of:
connecting a web cache service that is located on said mobile platform to said child proxy server.

17. The method of claim 16 where in said web cache service stores web pages.

18. The method of claim 17 wherein said child proxy server accesses said web pages in said web cache service if said UCD requests access to said web pages.

19. The method of claim 13 wherein said UCD connects to said child proxy server using a first group of TCP settings and wherein said child and parent proxy servers communicate using a second group of TCP settings to optimize said persistent link.

20. A method for providing a communications link for mobile platforms via a satellite, comprising the steps of:
connecting a parent proxy server to a ground station;
providing a transceiver on a mobile platform;
connecting a child proxy server to said transceiver;
establishing a communications link between said transceiver and said ground station via a satellite; and
setting transmission control protocol (TCP) parameters of said communications link between said child and parent proxy servers for satellite links.

21. The method of claim 20 further comprising the step of:
connecting a distributed communications system to said parent proxy server;

22. The method of claim 20 further comprising the step of:
connecting a user communication device (UCD) to said child proxy server.

23. The method of claim 23 wherein said UCD connects to said child proxy server using a first group of TCP settings and wherein said child and parent proxy servers communicate using a second group of TCP settings.
